(19) United States
(12) Patent Application Publication
(10) Pub. No.: US 2025/0083987 A1
(43) Pub. Date: Mar. 13, 2025

(54) GLASS CONTAINER BLOW MOLDING, MOLDS, AND MOLD BOTTOM PLATES

(71) Applicant: Owens-Brockway Glass Container Inc., Perrysburg, OH (US)

(72) Inventor: Stefanie McCrudden, Monheim (DE)

(21) Appl. No.: 18/826,830

(22) Filed: Sep. 6, 2024

Related U.S. Application Data
(60) Provisional application No. 63/582,232, filed on Sep. 12, 2023.

(51) Int. Cl. C03B 9/335; B65D 1/02; C03B 9/38

(52) U.S. Cl. CPC C03B 9/335; C03B 9/3866; B65D 1/0276

(57) ABSTRACT

Disclosed is a method of blow molding glass containers that includes blow molding a first glass container with a first lower portion configuration using a common mold body and a first interchangeable mold bottom plate corresponding to the first lower portion configuration of the first glass container; and blow molding a second glass container with a second lower portion configuration different from the first lower portion configuration and using the common mold body and a second interchangeable mold bottom plate different from the first mold bottom plate and corresponding to the second lower portion configuration of the second glass container. Also disclosed are interchangeable mold bottom plates, a mold body common to the mold bottom plates, and blow molds including the plates and the common mold body.

### TECHNICAL FIELD

This patent application discloses innovations in glass container blow molding, and to blow molds and, more particularly, to mold bottom plates.

### BACKGROUND

A blow mold in a typical glassware forming machine includes a mold body having a pair of longitudinally-split semi-cylindrical halves that are brought together around a round upper end of a unitary mold bottom plate to establish a blow mold cavity. The bottom plate is a pedestal-like component that includes a raised central portion to define a push-up or punt in a base of a glass container. U.S. Pat. No. 7,958,749 illustrates this type of equipment. A circumferentially extending radially peripheral upper portion of the bottom plate mates with a corresponding circumferentially extending radially peripheral lower portion of the mold body at a horizontal parting line or “bottom match” at a lower end of the mold. The radially peripheral upper portion of the bottom plate is usually at or below the elevation of an uppermost surface of the punt of the bottom plate. Therefore, the bottom match is at or below the uppermost surface of the punt and, thus, a significant portion of an insweep of a glass container—the insweep is that portion of a glass container that transitions or “sweeps” inwardly from a body of the container to a base of the container—is established by the mold body. Accordingly, there is no opportunity to customize the insweep with different configurations, e.g., different geometries, different sizes, or different embossments or debossments, unless both the mold body and the mold bottom plate are changed out, which is costly and time-consuming. Also, because of the relatively low elevation of the bottom match, there is little surface area for insweep decoration. Additionally, the shape or size of the insweep itself of a glass container cannot be customized unless the mold body of the container itself is customized because the majority of the insweep is established by the mold body.

### SUMMARY OF THE DISCLOSURE

In accordance with an aspect of the present disclosure, there is provided a method of blow molding glass containers. The method includes blow molding a first glass container with a first lower portion configuration using a common mold body and a first interchangeable mold bottom plate corresponding to the first lower portion configuration of the first glass container. The method also includes blow molding a second glass container with a second lower portion configuration different from the first lower portion configuration and using the common mold body and a second interchangeable mold bottom plate different from the first mold bottom plate and corresponding to the second lower portion configuration of the second glass container.

In accordance with another aspect of the disclosure, there is provided a glass container blow mold that includes a mold body establishing a mold body cavity and including a circumferentially extending body outer wall having a lower mating surface, and an interchangeable mold bottom plate establishing a bottom plate cavity having a first configuration. The mold bottom plate includes a circumferentially extending wall circumscribing a longitudinal central axis, and a mold mating wall extending axially and radially outwardly from the circumferentially extending wall and having an upper mating surface that mates with the lower mating surface of the mold body and also having an interior surface that extends axially and radially inwardly. The mold bottom plate also includes an axial end wall extending axially and radially inwardly from the circumferentially extending wall across the longitudinal central axis and having an interior surface that includes a punt uppermost surface that extends axially inwardly and radially outwardly from the punt uppermost surface toward the interior surface of the mold mating wall.

### BRIEF DESCRIPTION OF THE DRAWINGS

FIG. 1 is a fragmentary, elevational, cross-sectional view of a glass container blow mold including a mold body and a first interchangeable mold bottom plate in accordance with an illustrative embodiment of the present disclosure.

FIG. 1A is a fragmentary, elevational, cross-sectional view of a glass container blow mold including the mold body of FIG. 1 and a second interchangeable mold bottom plate in accordance with another embodiment of the present disclosure.

FIG. 2 is a perspective quarter sectional view of the mold bottom plate of FIG. 1.

FIGS. 3A-3E are two-dimensional views of embossments or debossments in accordance with illustrative embodiments of the present disclosure.

FIG. 4 is an elevational view of a first glass container formed in accordance with an illustrative embodiment of a method of the present disclosure and using the mold of FIG. 1.

FIG. 4A is an elevational view of a second glass container formed in accordance with an illustrative embodiment of a method of the present disclosure and using the mold of FIG. 1A.

FIGS. 5A-5D are elevational views of containers formed in accordance with the method of the present disclosure.

FIG. 6 is a fragmentary, elevational, cross-sectional view of a glass container blow mold including a mold body and a third interchangeable mold bottom plate in accordance with another illustrative embodiment of the present disclosure.

FIG. 6A is a fragmentary, elevational, cross-sectional view of a glass container blow mold including the mold body of FIG. 6 and a fourth interchangeable mold bottom plate in accordance with an illustrative embodiment of the present disclosure.

FIG. 7 is a perspective quarter sectional view of the mold bottom plate of FIG. 6.

FIG. 7A is a perspective quarter sectional view of the mold bottom plate of FIG. 6A.

FIGS. 8 and 8A are elevational views of profiles of third and fourth glass containers formed in accordance with one or more methods of the present disclosure and using the blow molds shown in FIGS. 6 and 6A.

### DETAILED DESCRIPTION

The present disclosure includes a glass container blow mold for a glassware forming machine that addresses one or more of the deficiencies described in the background. More specifically, the present disclosure provides a glass container blow mold including a common mold body and an interchangeable mold bottom plate that can be interchanged with other interchangeable mold bottom plates to customize lower portions (insweeps, bases, and/or punts) of glass containers with potential for lower costs and more production time savings.

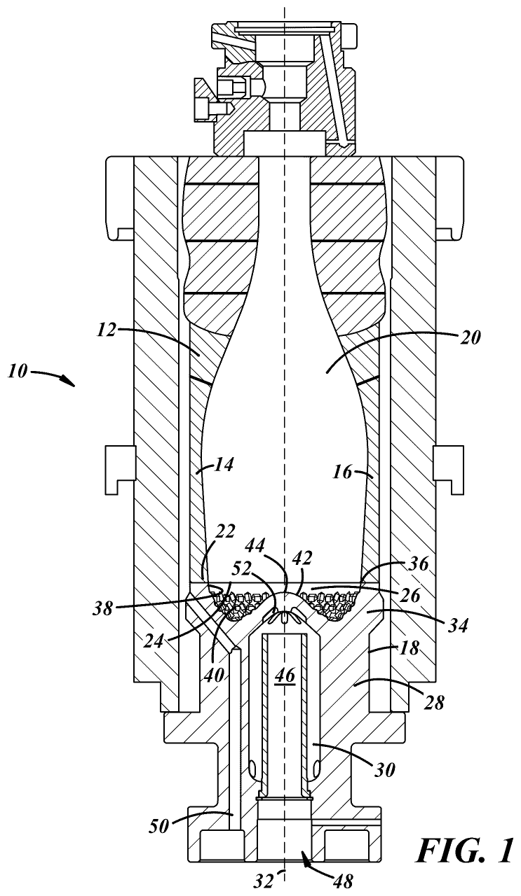

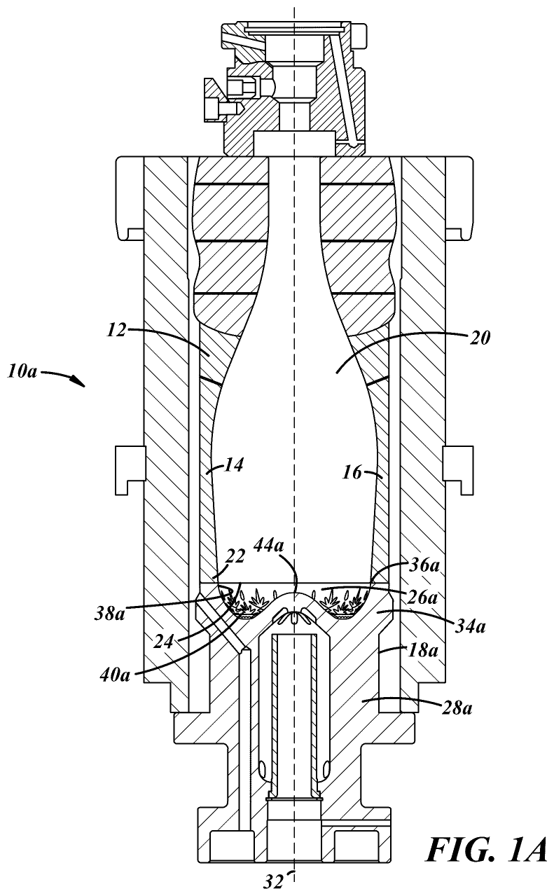

With specific reference to the drawing figures, FIG. 1 shows an illustrative embodiment of a glass container blow mold 10 for blow molding a glass container. The blow mold 10 includes a mold body 12 that may include multiple portions, for example, two longitudinal halves 14, 16, closable around a first interchangeable mold bottom plate 18 of the blow mold 10. The mold body 12 establishes a mold body cavity 20 and includes a circumferentially extending body outer wall 22 that has a lower mating surface 24. In the illustrated example, the mold body 12 defines a body portion, a shoulder portion, and part of a neck portion of a glass container.

The mold bottom plate 18 establishes a bottom plate cavity 26 and defines a lower portion, including a punt, a base, and an insweep, of a glass container. The bottom plate cavity 26 may have a first configuration to establish a first lower portion configuration of a container, for instance, a first insweep configuration such as a first ornamental insweep configuration, as will be discussed in further detail herein below. The bottom plate 18 includes a circumferentially extending wall 28 and a cooling passage 30 that extends along a longitudinal central axis 32 radially inwardly of the wall 28.

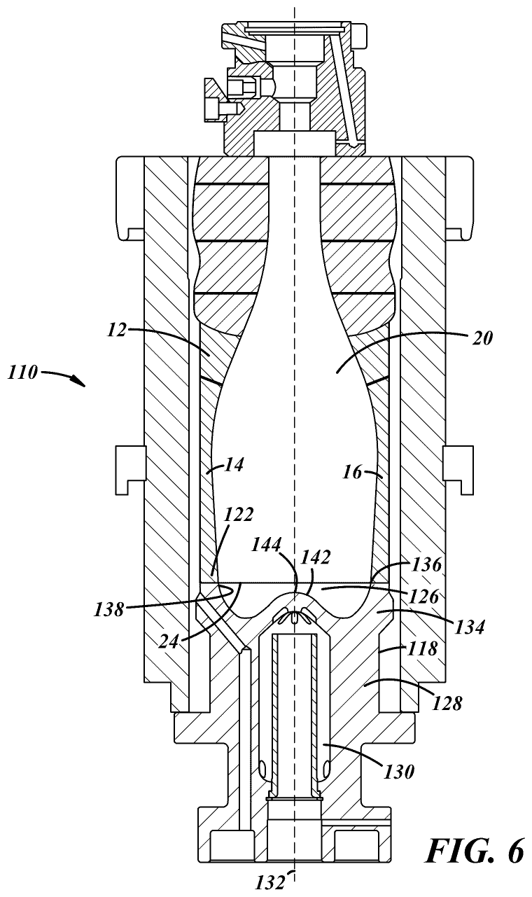

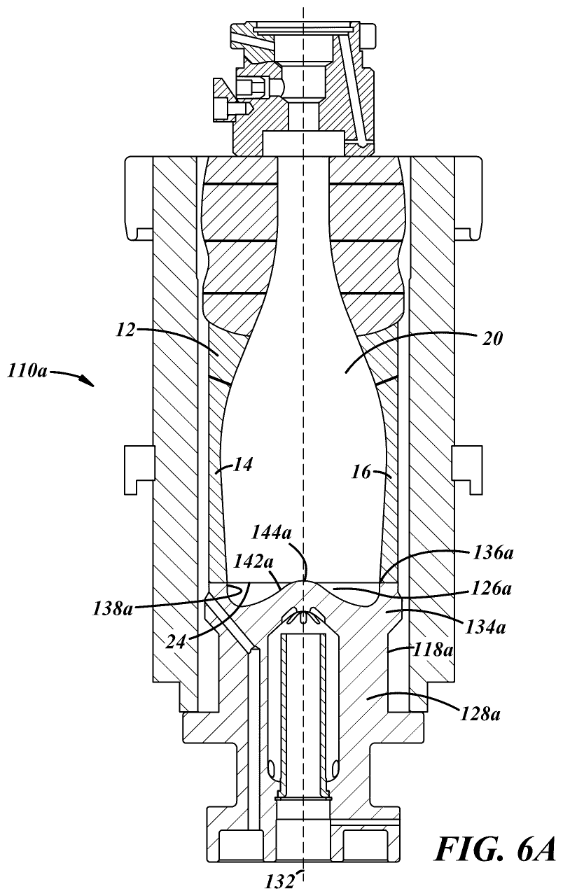

The mold bottom plate 18 also includes a mold mating wall 34 that may extend axially and radially outwardly from the circumferentially extending wall 28 and has an upper mating surface 36 that mates with the lower mating surface 24 of the mold body 12. The mold mating wall 34 also includes an interior surface 38 that may extend axially and radially inwardly from the upper mating surface 36 to at least partially establish an insweep of a glass container and carries an insweep configuration, which, in the example illustrated in FIG. 1, includes embossments or debossments 40. In other examples, the insweep configuration may include one or more particular geometries, for instance, faceted surfaces, curved or straight surfaces, or any other ornamental features, surfaces, or ornamentation of any kind. In additional examples, the insweep configuration may include one or more particular sizes, for instance, taller or shorter axial heights, as will be described further herein below with respect to FIGS. 6-8A. In one embodiment, the interior surface 38 may taper inward toward the longitudinal central axis 32. In another embodiment, the interior surface 38 may include a short straight taper axially away from the upper mating surface 36 followed by a gentle curve. In another embodiment, the interior surface 38 may extend substantially along a horizontal plane (i.e., flat) and may be rectangularly shaped or of other non-round shape.

The mold bottom plate 18 also includes an axial end wall 42 extending axially and radially inwardly from the circumferentially extending wall 28 across the longitudinal central axis 32. The axial end wall 42 has a punt peak or uppermost surface 44 that is spaced axially inwardly away from the upper mating surface 36, and the end wall 42 extends axially inwardly and radially outwardly away from the punt uppermost surface 44 and merges with the interior surface 38 of the mold mating wall 34. A typical glass container has a bottom with a recessed bottom surface that is radially and circumferentially surrounded by a bottommost surface or base on which the container rests. The recessed bottom surface is known in the art as a punt or push-up. Some containers, such as wine bottles have significantly deeper punts than other containers, such as food jars. The mold bottom plate 18 may be composed of metal alloy material, such as a high copper alloy. Examples of alloys that may be used in the composition of the mold bottom plate 18 are commercially available under the tradename AMPCOLOY®, although this example is for illustrative purposes. The mold bottom plate 18 may be composed of any material suitable for good thermal stability.

While the blowing step of forming a glass container occurs, the mold body 12 and the mold bottom plate 18 may be at around the same temperature. The mold bottom plate 18 also may carry a cooling tube 46 that may extend into the cooling passage 30 and may be part of an inlet path 48 through the cooling tube 46 and an outlet path 50 between the cooling tube 46 and the circumferentially extending wall 28. Cooling fluid may flow through the cooling tube 46 and may be supplied from any suitable source. An axially lower surface of the axial end wall 42 may include cooling debossments 52 which may be circumferentially spaced equidistant from each other and configured to receive cooling fluid directly from an outlet of the cooling tube 46.

A typical conventional mold bottom plate and mold body result in a horizontal parting line that is only about one to four millimeters from a bottommost surface or base of a glass container produced therefrom. Accordingly, a significant portion of an insweep of a conventional glass container is formed by the mold body.

In contrast, and with reference again to FIG. 1, here the configuration of the presently disclosed mold bottom plate 18 and mold body 12 results in a parting line elevation that is about four to ten times higher than that resulting from a typical conventional mold bottom plate. For example, use of the presently disclosed mold bottom plate 18 and mold body 12 may result in a parting line elevation of 22 mm from the bottommost surface of a container, for example, a bottle, having a height of 280 mm. In another embodiment, the parting line elevation may be 30 mm from the bottommost surface of a bottle with a height of 283 mm. In yet another embodiment, the parting line elevation may be 35 mm above a bottommost surface of a bottle with a height of 280 mm. In yet another embodiment, the parting line elevation may be 50 mm above a bottommost surface of a bottle with an height of 283 mm. In yet another embodiment, the parting line elevation may be 24 mm from the bottommost surface of a bottle with a height of 110 mm. In yet another embodiment, the parting line elevation may be 35 mm from the bottommost surface of a bottle with a height of 229 mm. Accordingly, the bottom plate 18 may have a bottom plate cavity with a longitudinal depth between 20 mm and 50 mm, between 25 mm and 45 mm, or even between 30 mm and 40 mm, and may be used in conjunction with containers of varying container heights.

Also, the lower mating surface 24 of the mold body 12 and the upper mating surface 36 of the mold bottom plate 18 meet below a container-to-container contact band (not pictured). A contact band is the widest dimension (e.g., largest diameter or largest horizontal width) of a bottle such that when identical bottles are placed in physical contact side by side with their bases or bottommost surfaces thereof resting on a common surface, the bottles are touching at that contact band. For example, a typical 750 mL capacity sparkling wine bottle may have a contact band at a distance of approximately 89-92 mm axially away from the bottle bottom or bottommost surface of the container or bottle base. Even a bottom plate 18 having a bottom plate cavity 26 of a longitudinal depth of 50 mm will be below the contact band. In any event, a bottom match plane at which the upper mating surface 36 of the mold bottom plate 18 and the lower mating surface 24 of the mold body 12 meet is below the contact band of the container or bottle.

The mold bottom plate 18 may have a bottom plate cavity 26 with a longitudinal depth between 20 to 50 mm with the bottom match plane also being at a lower elevation than the contact band of the bottle or container when the contact band is greater than 20 mm from the bottommost surface of the bottle or container. For example, in the case of a bottle or other container having a contact band at 34 mm above the base of the bottle or container, a mold bottom plate 18 may have a bottom plate cavity 26 with a longitudinal depth in the range of 20 to 30 mm. In the embodiment illustrated in FIGS. 1 and 1A, the ratio of the longitudinal depth of the bottom plate cavity 26 to the overall longitudinal length of the bottle or container may be in the range of 1:15 to 1:4.8, more particularly 1:12.5 to 1:7.5, or even more particularly 1:11 to 1:9. Accordingly, a bottle or container insweep is either entirely or nearly entirely defined by the bottom plate 18, and is either not all defined by the mold body 12 or very little of the insweep is defined by the mold body 12. By way of another example, the range of ratios of the longitudinal depth of the bottom plate cavity 26 to an inner diameter (or maximum inner dimension) of the mold bottom plate 18 at the upper mating surface may be 1:2 to 1:5, or more particularly 1:3 to 1:4. As used herein, the inner diameter of the mold bottom plate 18 is the inner diameter of the mold mating wall 34 if the mold mating wall 34 is cylindrical in shape. In the case of non-round (i.e., rectangular, square, or oval) mold mating walls 34, the inner diameter or maximum inner dimension of the mold bottom plate 18 at the upper mating surface would be a maximum width of the upper mating surface 36 along the horizontal plane.

FIG. 1A illustrates another embodiment of the present disclosure. A glass mold 10a includes the mold body 12 of FIG. 1 that includes the two longitudinal halves 14, 16 closable around a second interchangeable mold bottom plate 18a of the mold 10a. The mold body 12 of FIG. 1A is identical to mold body 12 of FIG. 1, but the mold bottom plate 18a differs from the mold bottom plate 18 of FIG. 1. Accordingly, the mold body 12 is common to, or shared by, both mold bottom plates 18, 18a. And the mold bottom plates 18, 18a and the mold body 12 are matched sets such that they are designed and configured to be used with one another to produce containers that have differently ornamented insweeps but that are otherwise identical.

The mold bottom plate 18a establishes a bottom plate cavity 26a and defines a lower portion, including a punt, a base, and an insweep, of a glass container. The bottom plate cavity 26a may have a second configuration different from the first configuration of the bottom plate cavity 26 of the first interchangeable mold bottom plate 18 of FIG. 1. The second configuration of the bottom plate cavity 26a establishes a second lower portion configuration of a second container different from the first container. For instance, the second lower portion configuration may include a second insweep configuration, such as a second ornamental insweep configuration, that is different from the first insweep configuration of the bottom plate cavity 26 of the mold bottom plate 18 of FIG. 1. The bottom plate 18a includes a circumferentially extending wall 28a and a mold mating wall 34a that may extend axially and radially outwardly from the circumferentially extending wall 28a and has an upper mating surface 36a that mates with the lower mating surface 24 of the mold body 12.

The mold mating wall 34a includes an interior surface 38a that carries ornamental embossments or debossments 40a that differ from the embossments or debossments 40 of FIG. 1 in shape, configuration, spacing, and/or in axial distance from a punt uppermost surface 44a and/or from the lower mating surface 24 of the mold body 12. In FIG. 1, for example, the embossments or debossments 40 are of a unique ornamental appearance and do not extend axially above the punt uppermost surface 44. In contrast, in FIG. 1A, the embossments or debossments 40a are of a different ornamental appearance and do extend axially above the punt uppermost surface 44. The embossments or debossments 40 begin axially below the upper mating surface 36 of the mold bottom plate 18. This is to prevent a mold lock condition which may result in cracked or broken glass containers. By way of example only, the embossments or debossments 40 may begin axially below the upper mating surface 36 of the mold bottom plate 18 by at least 3 mm. Because the bottom plate cavities 26, 26a of the mold bottom plates 18, 18a are deeper relative to conventional mold bottom plates, the mold bottom plates 18, 18a may define greater than 50% of a glass bottle insweep, more particularly 55-99% of a glass bottle insweep, even more particularly 65-99% of a glass bottle insweep, and even more particularly 75-99% of a glass bottle insweep, in contrast to the conventional mold bottom plate of the prior art, which typically defines much less than 50% of the insweep. The mold bottom plate 18, 18a also may define 75-100% of the embossments/debossments on an outside surface of the glass bottle. Conventional mold bottom plates do not define any embossments/debossments.

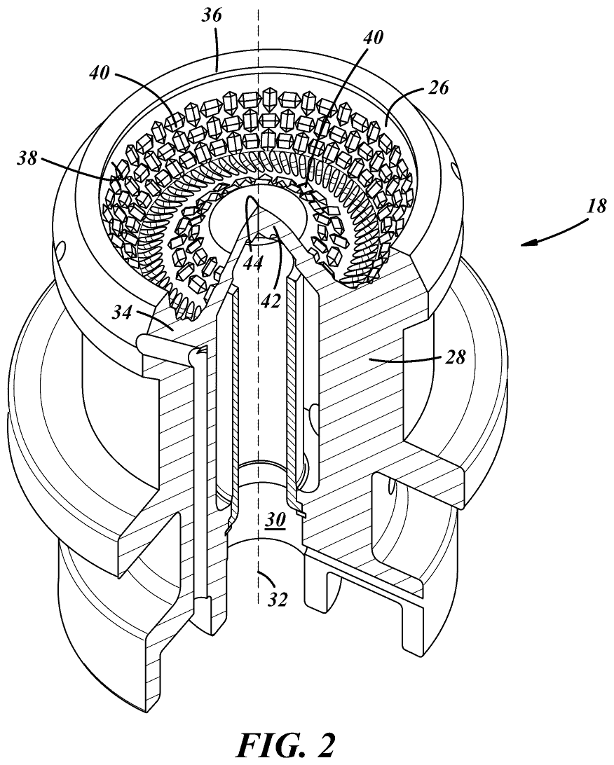

FIG. 2 is a perspective quarter sectional view of an embodiment of the mold bottom plate 18 of FIG. 1, showing another view of the upper mating surface 36 and the interior surface 38. The interior surface 38 extends axially and radially inwardly, and carries ornamental embossments or debossments 40 radially inwardly and outwardly with respect to knurling debossments on or in a lowermost portion or base of the interior surface 38 of the mold bottom plate 18.

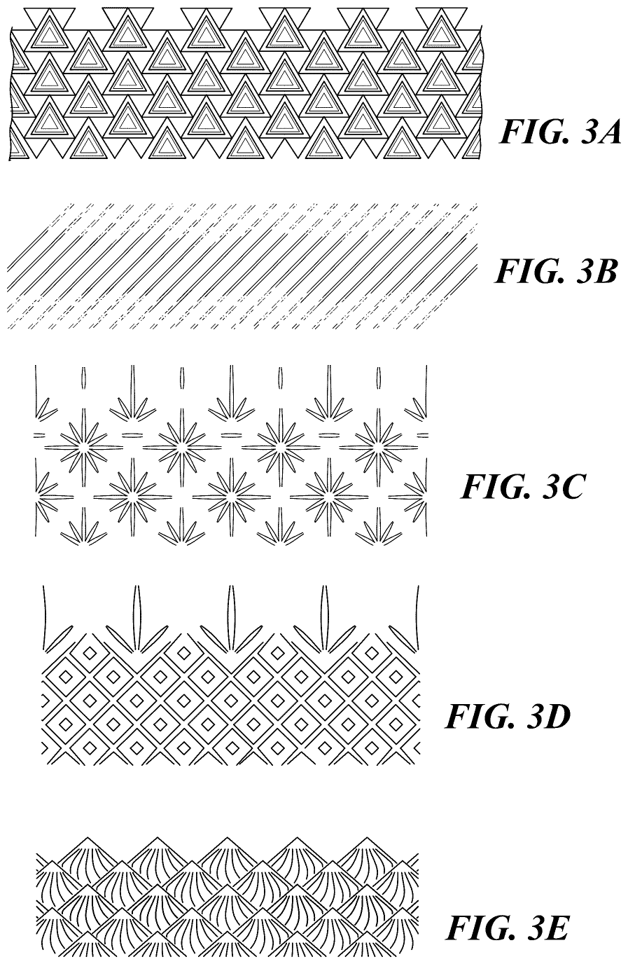

As illustrated in FIGS. 3A-E, embossments or debossments may comprise different shapes and patterns, which may include indicia like text, logos, and the like. By way of example only, and not meant to be limited to the following list, the shapes and patterns may include, squares, triangles, starbursts, trapezoids, linear stripes, or a combination thereof, or any other shapes and patterns suitable for use on a glass container insweep.

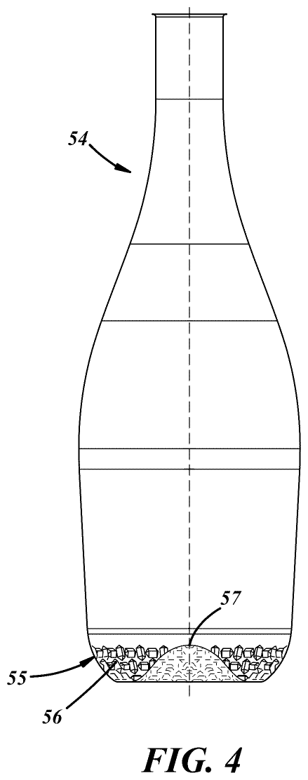

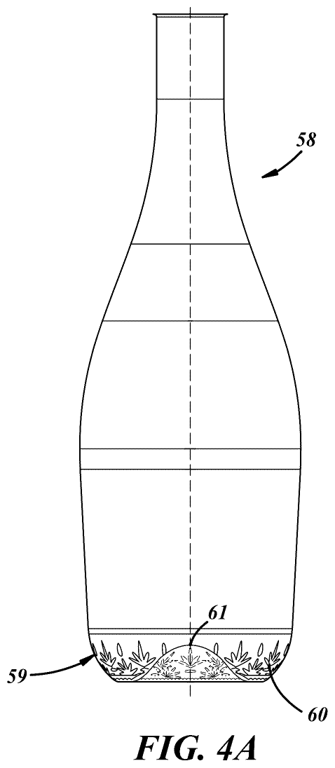

FIGS. 4 and 4A illustrate resulting glass containers 54, 58 that may be formed by a presently disclosed method of manufacturing glass containers. In FIG. 4, a first glass container 54 is shown as formed by the mold 10 of FIG. 1. More specifically, the first glass container has an insweep 55 with a first ornamental insweep configuration 56, and is formed from the mold body 12 and the first interchangeable mold bottom plate 18 of FIG. 1. The first ornamental insweep configuration 56 corresponds to embossments or debossments 40 of the mold bottom plate 18 and does not extend axially above a peak of a punt 57 of the container 54.

In FIG. 4A, a second glass container 58 is shown as formed by the mold 10a of FIG. 1A. More specifically, the second glass container 54 has an insweep 59 with a second ornamental insweep configuration 60 is formed using the mold body 12 and the second interchangeable mold bottom plate 18a of FIG. 1A. The second ornamental insweep configuration 60 may differ from the first ornamental insweep configuration 56. The second ornamental insweep configuration 60 corresponds to embossments or debossments 40a of the mold bottom plate 18a and extends axially beyond or above a peak of a punt 61 of the container 58. Those of ordinary skill in the art would recognize that the containers 54, 58 also include bodies extending away from the insweeps 55, 59, shoulders extending away from the bodies, necks extending away from the shoulders, and bases or bottommost surfaces thereof on which the containers 54, 58 rest. Because the mold body 12 is common to multiple mold bottom plates 18, 18a, only the interchangeable mold bottom plates 18, 18a need to be changed out and replaced with one another or other interchangeable mold bottom plates to form glass containers with customized insweeps and/or punts. Therefore, the molds 10, 10a differ from each other only by the mold bottom plates 18, 18a.

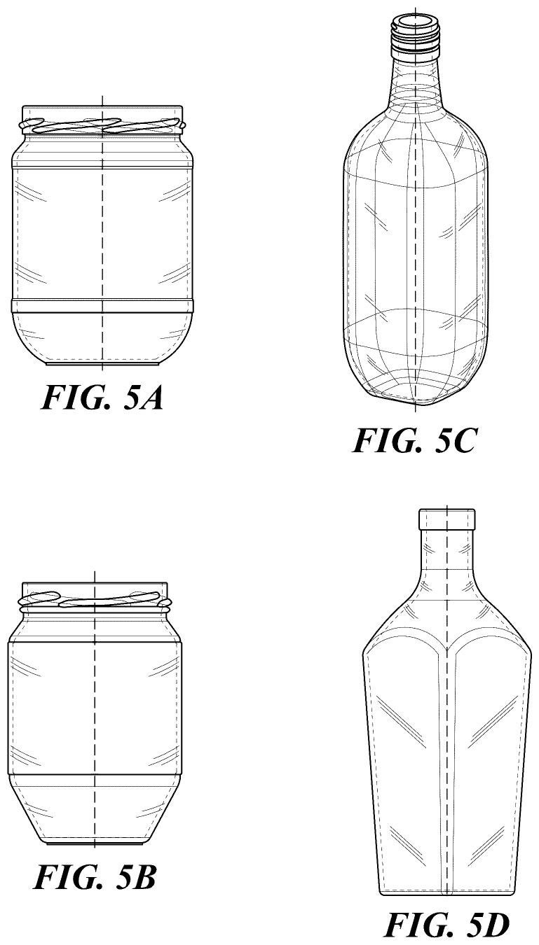

FIGS. 5A-5D illustrate additional embodiments of glass containers formed by the method described above. FIGS. 5C-D illustrate glass containers having rectangular shaped bases, for example, square shaped bases. In these embodiments, mold bottom plates (not shown) may have mold mating walls that may be substantially rectangular or square in shape and axial end walls that may be substantially rectangular or square and parallel to a horizontal plane.

FIGS. 6 through 8A illustrate another illustrative embodiment of blow molds, and containers produced by the blow molds. This embodiment is similar in many respects to the embodiments of FIGS. 1-5D and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

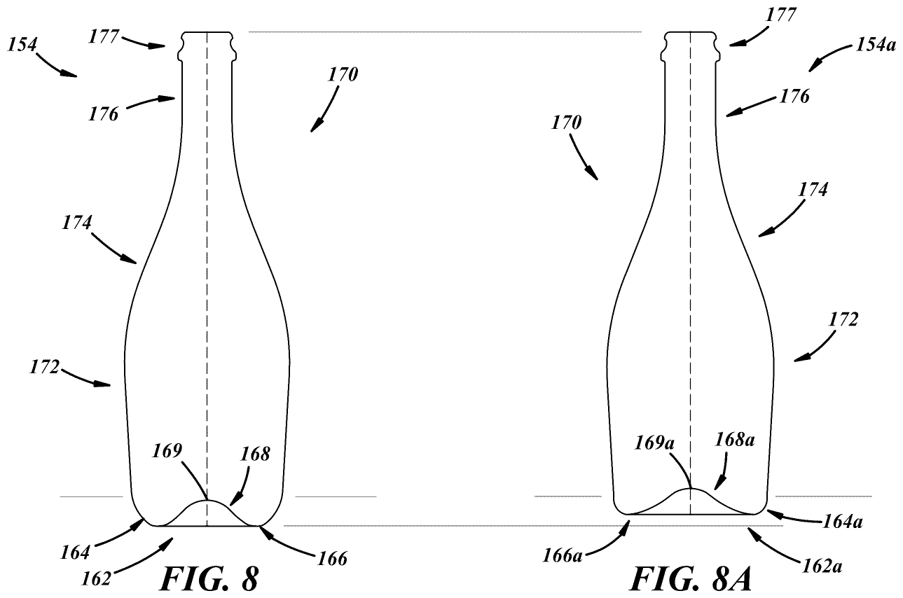

FIGS. 6 and 6A show an illustrative embodiment of glass container blow molds 110, 110a for blow molding glass containers. The blow molds 110, 110a include the mold body 12 shown in FIGS. 1 and 1A and that may include the two longitudinal halves 14, 16 that establish the mold body cavity 20, and the circumferentially extending body outer wall 22 having the lower mating surface 24. The blow molds 110, 110a also include third and fourth interchangeable mold bottom plates 118, 118a that establish bottom plate cavities 126, 126a and that define lower portion configurations of glass containers, for example, punts, bases, and insweeps of third and fourth glass containers as will be described in further detail below with respect to FIGS. 8 and 8A. Terms like first, second, third, and fourth are not used to define a serial or numerical limitation but instead are used to relatively distinguish or identify different bottom plates or different containers from one another. Accordingly, for example, the third and fourth bottom plates 118, 118a may be referred to as first and second bottom plates in the claims or elsewhere. The bottom plates 118, 118a include circumferentially extending walls 128, 128a circumscribing a longitudinal central axis 132 radially inwardly of the walls 128, 128a. The mold bottom plates 118, 118a also include mold mating walls 134, 134a that may extend axially and radially outwardly from the circumferentially extending walls 128, 128a and that establish upper mating surfaces 136, 136a that mate with the lower mating surface 24 of the mold body 12.

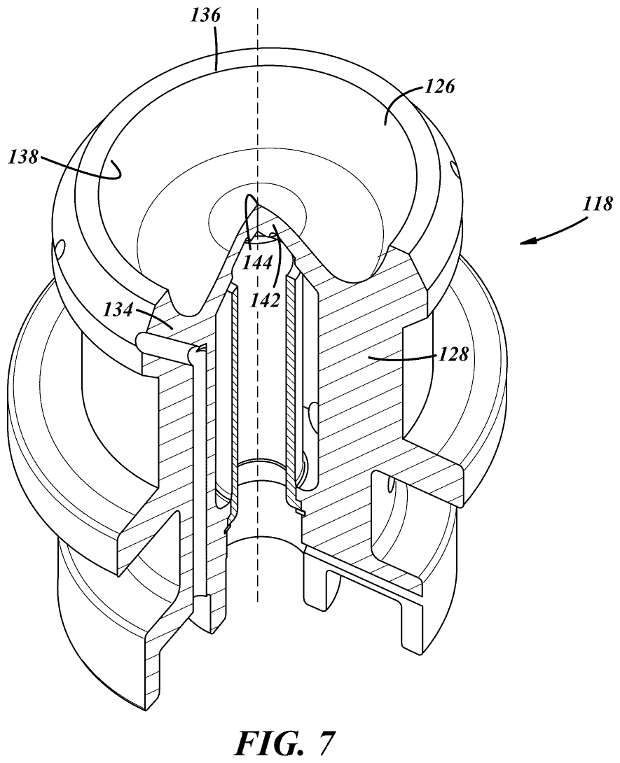

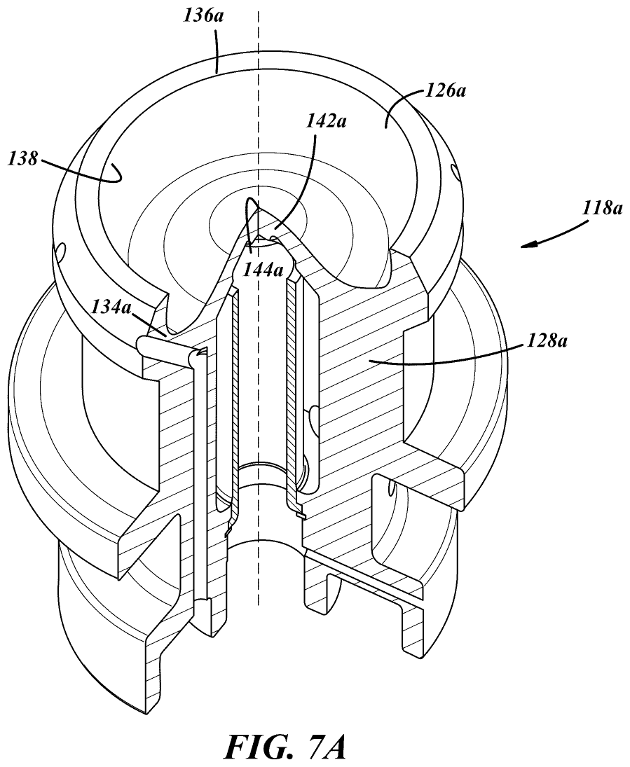

Referring to FIGS. 6 through 7A, the mold mating walls 134, 134a also include interior surfaces 138, 138a that may extend axially and radially inwardly from the upper mating surfaces 136, 136a to at least partially establish insweeps of glass containers and carry or establish insweep configurations that may be of different sizes and contours, as shown in FIGS. 6, 6A, 7, and 7A. In the example illustrated in FIGS. 6 and 7, an insweep configuration is shown that includes a smoothly contoured incurvate surface and that is relatively deep or tall. In the example illustrated in FIGS. 6A and 7A, a different insweep configuration is shown that includes a compound surface having a radially outward straight-tapered portion transitioning into a smoothly contoured incurvate portion and that is relatively shallow or short in contrast to the relatively deeper or taller insweep configuration of FIGS. 6 and 7. The mold bottom plates 118, 118a also include axial end walls 142, 142a that extend axially and radially inwardly from the circumferentially extending walls 128, 128a across the longitudinal central axis 132 and that have punt peaks or uppermost surfaces 144, 144a and carry or establish punt configurations that may be of different sizes and contours, as shown in FIGS. 6, 6A, 7, and 7A. In the example illustrated in FIG. 6, the uppermost surface 144 is spaced axially inwardly away from the upper mating surface 136, such that the uppermost surface 144 is recessed below or shy of the upper mating surface 136. In contrast, in the example illustrated in FIG. 6A, the uppermost surface 144a is spaced axially outwardly away from the upper mating surface 136a, such that the uppermost surface 144a is projecting above or proud of the upper mating surface 136. In other embodiments, the uppermost surfaces 144, 144a may be axially flush with the upper mating surface 136. The end walls 142, 142a extend axially inwardly and radially outwardly away from the uppermost surfaces 144, 144a and merge with the interior surfaces 138, 138a of the mold mating walls 134, 134a.

With continued reference to FIGS. 6 through 7A, the bottom plates 118, 118a may be used to produce differently sized containers. In the illustrated embodiment of FIGS. 6 and 7, the insweep configuration may include a relatively tall axial height to produce a relatively tall glass container of a particular volumetric capacity. As just an illustrative example, the mold 110 of FIG. 6 may produce a glass container having a volumetric capacity of 75 centiliters (cl), for instance, for a champagne bottle. In the illustrated embodiment of FIG. 6A, the insweep configuration may include a relatively short axial height to produce a relatively short glass container of a particular volumetric capacity. As just an illustrative example, the mold 110a of FIG. 6A may produce a glass container having a volumetric capacity of 70 centiliters (cl), for instance, for a sparkling wine bottle. Accordingly, the bottom plates 118, 118a may have first and second bottom plate cavity sizes that differ from one another. In other examples, the insweep and/or punt configurations may include one or more other particular geometries, for instance, faceted surfaces, curved or straight surfaces, ornamental features, surfaces, or ornamentation of any kind, or any other suitable configurations.

FIGS. 8 and 8A show embodiments of third and fourth glass containers 154, 154a that may be formed by the presently disclosed apparatus and method. The glass containers 154, 154a have lower portions 162, 162a that are configured differently from one another. For example, the third glass container 154 has a taller lower portion 162 compared to a shorter lower portion 162a of the fourth glass container 154a. The lower portions 162, 162a include insweeps 164, 164a, bases 166, 166a, and punts 168, 168a. The third glass container 154 is formed by the mold 110 of FIG. 6 including the mold body 12 of FIGS. 1, 1A, 6, and 6A and the mold bottom plate 118 of FIG. 6, and has the insweep 164 with an insweep configuration corresponding to the interior surface 138 of the bottom plate 118. The fourth glass container 154a is formed by the mold 110a of FIG. 6A including the mold body 12 of FIGS. 1, 1A, 6, and 6A and the mold bottom plate 118a of FIG. 6A. Accordingly, the fourth glass container 154a has the insweep 164a with an insweep configuration corresponding to the interior surface 138a of the bottom plate 118a and differing from the insweep configuration of the third glass container 154. The third and fourth glass containers 154, 154a have the punts 168, 168a with uppermost surfaces 169, 169a corresponding to the uppermost surfaces 144, 144a of the bottom plates 118, 118a. The punt 168a of the fourth glass container 154a differs from the punt 168 of the third glass container 154 in that the punt 168a projects proudly with respect to a bottom match plane or horizontal parting line on the fourth glass container 154a whereas the punt 168 of the third glass container 154 is recessed shy of a bottom match plane or horizontal parting line on the third glass container 154. Therefore, the third and fourth glass containers 154, 154a have lower portion configurations that differ in geometry of their respective insweeps 164, 164a and punts 168, 168a but also may differ in size(s).

With continued reference to FIGS. 8 and 8A, in contrast to the different lower portions 162, 162a, the containers 154, 154a have identical or common upper portions 170, including a common body 172 extending away from the insweeps 164, 164a of the lower portions 162, 162a, a common shoulder 174 extending away from the common body 172, and a common neck 176 extending away from the common shoulder 174 and terminating in a common neck finish 177. The upper portion 170 may extend from the lower portions 162, 162a to top surfaces of the neck finish 177, whereas the lower portions 162, 162a may extend from the upper portion 170 to bottommost surfaces of the lower portions 162, 162a. Lines on the containers 154, 154a between the lower and upper portions 162, 162a and 170 may be referred to as bottom match planes or horizontal parting lines established by tiny gaps between the lower mating surface 24 of the mold body 12 and the upper mating surfaces 36, 36a, 136, 136a of the bottom plates 18, 18a, 118, 118a. For containers having punt peaks that project proudly axially outwardly from the bottom match planes or horizontal parting lines, the entireties of the punts may be considered part of the lower portions of the containers.

Because the mold body 12 of the different molds 10, 10a, 110, 110a of FIGS. 1, 1A, 6, and 6A is common to multiple different interchangeable mold bottom plates 18, 18a, 118, 118a, only the interchangeable mold bottom plates 18, 18a, 118, 118a need to be changed out and replaced with one another to form glass containers with different lower portions. Therefore, the molds 10, 10a, 110, 110a differ from each other only by the mold bottom plates 18, 18a, 118, 118a.

Accordingly, and with reference to the drawing figures, the presently disclosed method includes blow molding a first glass container 54, 154 with a first lower portion configuration 55, 162 using a common mold body 12 and a first interchangeable mold bottom plate 18, 118 having a first configuration corresponding to the first lower portion configuration 55, 162 of the first glass container 54, 154. For example, the first lower portion configuration 55, 162 may include first embossments (or debossments), first geometry, and/or first size, corresponding to the first lower portion configuration 55, 162. More specifically, the method may include receiving a blank or parison in a blow mold 10, 110 including the common mold body 12 and the first interchangeable mold bottom plate 18, 118. The parison may be received from a blank molding operation that uses blank molding equipment to produce the parison from a gob of molten glass. The method also may include closing the common mold body 12 around the first interchangeable mold bottom plate 18, 118, for instance, moving halves 14, 16 of the common mold body 12 toward one another to close the common mold body 12. The method further may include introducing compressed air into an open end of the parison to expand at least some exterior surfaces of the parison into contact with corresponding interior surfaces of the blow mold 10, 110 including mold surfaces of the common mold body 12 and a mold surface of the first interchangeable bottom plate 18, 118 to produce a first glass container 54, 154. The method additionally may include opening the common mold body 12 from around the first interchangeable mold bottom plate 18, 118, for instance, moving the halves 14, 16 of the common mold body 12 away from one another to open the common mold body 12. The method moreover may include taking the finished container 54, 154 out of the blow mold 10, 110, for instance, by a blow side takeout mechanism that may have tongs to grab an upper portion of the first glass container 54, 154 and lift the first glass container 54, 154 up and out of the blow mold 10, 110.

Thereafter, the aforementioned method steps may be repeated, for instance, until it is desired to produce a different container having a different lower portion configuration. At that point, the method may also include exchanging a second interchangeable mold bottom plate 18a, 118a for the first interchangeable mold bottom plate 18, 118 relative to the common mold body 12, which may involve removing the first interchangeable mold bottom plate 18, 118 and replacing it with a second interchangeable mold bottom plate 18a, 118a. For example, the common mold body 12 may remain in place in an open position and the first interchangeable mold bottom plate 18, 118 may be replaced with the second interchangeable mold bottom plate 18a, 118a. In another example, the common mold body 12 may be removed, the first interchangeable mold bottom plate 18, 118 may be replaced with the second interchangeable mold bottom plate 18a, 118a, and then the common mold body 12 may be returned to its open position with respect to the second interchangeable mold bottom plate 18a, 118a.

The presently disclosed method also includes blow molding a second glass container 58, 154a with a second lower portion configuration 59, 162a different from the first lower portion configuration 55, 162 and using the common mold body 12 and the second interchangeable mold bottom plate 18a, 118a that is different from the first interchangeable mold bottom plate 18, 118 and having a second configuration corresponding to the second lower portion configuration 59, 162a. For example, the second lower portion configuration 59, 162a may include second embossments (or debossments) different from the first embossments, second geometry different from the first geometry, and/or second size different from the first size. More specifically, the method may include receiving a blank or parison in a blow mold 10a, 110a including the common mold body 12 and the second interchangeable mold bottom plate 18a, 118a. The parison may be received from a blank molding operation that uses blank molding equipment to produce the parison from a gob of molten glass. The method also may include closing the common mold body 12 around the second interchangeable mold bottom plate 18a, 118a, for instance, moving the halves 14, 16 of the common mold body 12 toward one another to close the common mold body 12. The method further may include introducing compressed air into an open end of the parison to expand at least some exterior surfaces of the parison into contact with corresponding interior surfaces of the blow mold 10a, 110a including mold surfaces of the common mold body 12 and a mold surface of the second interchangeable bottom plate 18a, 118a to produce the second glass container 58, 154a. The method additionally may include opening the common mold body 12 from around the second interchangeable mold bottom plate 18a, 118a, for instance, moving the halves 14, 16 of the common mold body 12 away from one another to open the common mold body 12. The method moreover may include taking the second glass container 58, 154a out of the blow mold 10a, 110a, and lifting the second glass container 58, 154a up and out of the blow mold 10a, 110a.

Thereafter, the aforementioned method steps may be repeated, for instance, until it is desired to produce the first glass container 54, 154 again, or even a third container having a different lower portion configuration from the first and second glass containers 54, 58, 154, 154a. At that point, the method may also include exchanging the first interchangeable mold bottom plate 18, 118 or a third interchangeable mold bottom plate for the second interchangeable mold bottom plate 18a, 118a relative to the common mold body 12, which may involve removing the second interchangeable mold bottom plate 18a, 118a and replacing it with the first interchangeable mold bottom plate 18, 118 or the third interchangeable mold bottom plate, respectively. In fact, the method may include any suitable quantity of different interchangeable mold bottom plates to produce any suitable quantity of different containers with different lower portion configurations.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A method of blow molding glass containers, comprising:
blow molding a first glass container with a first lower portion configuration using a common mold body and a first interchangeable mold bottom plate corresponding to the first lower portion configuration of the first glass container; and
blow molding a second glass container with a second lower portion configuration different from the first lower portion configuration and using the common mold body and a second interchangeable mold bottom plate different from the first interchangeable mold bottom plate and corresponding to the second lower portion configuration of the second glass container.

2. The method set forth in claim 1, wherein the first lower portion configuration comprises first embossments or debossments and the second lower portion configuration comprises second embossments or debossments different from the first embossments or debossments.

3. The method set forth in claim 1, wherein the first lower portion configuration defines a first geometry and the second lower portion configuration defines a second geometry different from the first geometry.

4. The method set forth in claim 1, wherein the first lower portion configuration defines a first size and the second lower portion configuration defines a second size different from the first size.

5. The method set forth in claim 1, wherein each of the first and second interchangeable mold bottom plates include:
a circumferentially extending wall circumscribing a longitudinal central axis,
a mold mating wall extending axially and radially outwardly from the circumferentially extending wall and having an upper mating surface that mates with a lower mating surface of the common mold body and an interior surface that extends axially and radially inwardly, and
an axial end wall extending axially and radially inwardly from the circumferentially extending wall across the longitudinal central axis and having an interior surface that includes a punt uppermost surface and wherein the axial end wall extends axially inwardly and radially outwardly from the punt uppermost surface toward the interior surface of the mold mating wall.

6. The method set forth in claim 5, wherein the punt uppermost surface is spaced axially inwardly from the upper mating surface of the mold mating wall.

7. The method set forth in claim 5, wherein a bottom match plane is at a lower elevation than a container-to-container contact band.

8. A glass container blow mold, comprising:
a mold body establishing a mold body cavity and including a circumferentially extending body outer wall having a lower mating surface; and
an interchangeable mold bottom plate establishing a bottom plate cavity having a first configuration and including:
a circumferentially extending wall circumscribing a longitudinal central axis,
a mold mating wall extending axially and radially outwardly from the circumferentially extending wall and having an upper mating surface that mates with the lower mating surface of the mold body and also having an interior surface that extends axially and radially inwardly, and
an axial end wall extending axially and radially inwardly from the circumferentially extending wall across the longitudinal central axis and having an interior surface that includes a punt uppermost surface and wherein the axial end wall extends axially inwardly and radially outwardly from the punt uppermost surface toward the interior surface of the mold mating wall.

9. The glass container blow mold set forth in claim 8, further comprising:
a second interchangeable mold bottom plate establishing a second bottom plate cavity having a second configuration different from the first configuration and including:
a second circumferentially extending wall circumscribing a second longitudinal central axis,
a second mold mating wall extending axially and radially outwardly from the second circumferentially extending wall and having a second upper mating surface that mates with the lower mating surface of the mold body and a second interior surface that extends axially and radially inwardly, and
a second axial end wall extending axially and radially inwardly from the second circumferentially extending wall across the second longitudinal central axis and having a second interior surface that includes a second punt uppermost surface and wherein the second axial end wall extends axially inwardly and radially outwardly from the second punt uppermost surface toward the second interior surface of the second mold mating wall.

10. The glass container blow mold set forth in claim 8, further comprising:
a cooling passage through which the longitudinal central axis extends; and
a cooling tube extending into the cooling passage and establishing an inlet path through the cooling tube and an outlet path between the cooling tube and the circumferentially extending wall.

11. The glass container blow mold set forth in claim 8, wherein an axial depth of the bottom plate cavity is 3 to 50 millimeters.

12. The glass container blow mold set forth in claim 8, wherein a bottom match plane is at a lower elevation than a container to container contact band.

13. The glass container blow mold set forth in claim 8, wherein a depth of the bottom plate cavity is 20 to 50 millimeters.

14. The glass container blow mold set forth in claim 8, wherein the mold mating wall tapers inward toward a longitudinal central axis to the axial end wall.

15. The glass container blow mold set forth in claim 8, wherein the first configuration includes first insweep embossments or debossments.

16. The glass container blow mold set forth in claim 15, wherein the second configuration includes second insweep embossments or debossments different from the first insweep embossments or debossments.

17. The glass container blow mold set forth in claim 9, wherein the first configuration includes a first bottom plate cavity size and the second configuration includes a second bottom plate cavity size different from the first bottom plate cavity size.

18. The glass container blow mold set forth in claim 8, wherein the mold mating wall is cylindrical.

19. The glass container blow mold set forth in claim 8, wherein the mold mating wall is rectangular.

20. The glass container blow mold set forth in claim 8, wherein the punt uppermost surface is spaced axially inwardly from the upper mating surface of the mold mating wall.
